(19) United States
(12) Patent Application Publication
(10) Pub. No.: US 2013/0222712 A1
(43) Pub. Date: Aug. 29, 2013

(54) 3D DISPLAY PANEL AND METHOD FOR MANUFACTURING 3D DISPLAY SHEET

(71) Applicants: Bin Fang, Shenzhen (CN); Chih-Wen Chen, Shenzhen (CN); Chia-Chiang Hsiao, Shenzhen (CN)

(72) Inventors: Bin Fang, Shenzhen (CN); Chih-Wen Chen, Shenzhen (CN); Chia-Chiang Hsiao, Shenzhen (CN)

(73) Assignee: SHENZHEN CHINA STAR OPTOELECTRONICS TECHNOLOGY CO, LTD, Shenzhen (CN)

(21) Appl. No.: 13/501,635

(22) PCT Filed: Mar. 6, 2012
(86) PCT No.: PCT/CN12/72009

§ 371 Date: Apr. 12, 2012

(30) Foreign Application Priority Data
Feb. 29, 2012 (CN) 201210049985.8

(51) Int. Cl. G02F 1/1335; B32B 37/18

(52) U.S. Cl. 349/15; 156/60

(57) ABSTRACT

The present invention provides a 3D display panel and a method for manufacturing a 3D display sheet. The method comprises the following steps: providing a polarizing film; and bonding a protective film and a quarter wave film to both sides of the polarizing film, respectively, wherein an outer surface of the quarter wave film is directly in contact with a medium, and the medium has an optical retardation value of zero. The present invention can improve the narrow viewing angle problem existing in the conventional 3D display.

### FIELD OF THE INVENTION

The present invention relates to a three-dimensional (3D) display panel and a method for manufacturing a 3D display sheet, and more particularly to a 3D display panel and a method for manufacturing a 3D display sheet for displaying 3D images.

### BACKGROUND OF THE INVENTION

Liquid crystal displays (LCDs) have been widely applied in electrical products. Currently, most of LCDs are backlight type LCDs which include a liquid crystal panel and a backlight module.

At present, the LCDs are capable of having a 3D image displaying function. For example, a 3D pattern retarder display, which has a half (1/2) wave plate and a quarter (1/4) wave plate being disposed at an outer side of an LCD panel, is capable of displaying 3D images.

In general, the pattern retarder display has left image pixels and right image pixels. The left image pixels are positioned at odd pixel rows (or even pixel rows) of the display, and the right image pixels are positioned at the other pixel rows thereof. When the light of the display passes through the half-wave phase retarders and the quarter-wave phase retarders with different orientations, the light is transformed into a left handed circularly polarized light and a right handed circularly polarized light, respectively. A user can use circular polarizer glasses with different polarized directions such that the user's left eye only sees images of the left image pixels, and the user's right eye only sees images of the right image pixels. Therefore, the 3D image effect of the display is achieved.

However, when a user squints at the conventional 3D display, the light rays emitted from the 3D display are likely to be non-circularly polarized light rays (such as elliptically polarized light), and thus an image crosstalk easily arises to deteriorate a 3D display quality. That is, the conventional 3D display is likely to have a narrow viewing angle problem.

### SUMMARY OF THE INVENTION

The present invention provides a 3D display panel and a method for manufacturing a 3D display sheet, so as to improve the narrow viewing angle problem existing in the conventional 3D display.

A primary object of the present invention is to provide a 3D display panel, and the 3D display panel comprises: a first substrate; a second substrate; a liquid crystal layer formed between the first substrate and the second substrate; a polarizer disposed at an outer side of the second substrate; and a 3D display sheet disposed at an outer side of the first substrate, wherein the 3D display sheet comprises a protective film, a polarizing film and a quarter wave film, and the polarizing film and the quarter wave film are disposed on the protective film in sequence, and an outer surface of the quarter wave film is directly in contact with a medium, and the medium has an optical retardation value of zero.

Another object of the present invention is to provide a 3D display panel, and the 3D display panel comprises: a first substrate; a second substrate; a liquid crystal layer formed between the first substrate and the second substrate; a polarizer disposed at an outer side of the second substrate; and a 3D display sheet disposed at an outer side of the first substrate, wherein the 3D display sheet comprises a protective film, a polarizing film and a quarter wave film, and the polarizing film and the quarter wave film are disposed on the protective film in sequence, and an outer surface of the quarter wave film is directly in contact with a medium, and the medium has an optical retardation value of zero, and an inner surface of the quarter wave film is directly in contact with the polarizing film, and the medium is a zero optical retardation film.

Still another object of the present invention is to provide a method for manufacturing a 3D display sheet of a 3D display panel, and the method comprises the following steps: providing a polarizing film; and bonding a protective film and a quarter wave film to both sides of the polarizing film, respectively, wherein an outer surface of the quarter wave film is directly in contact with a medium, and the medium has an optical retardation value of zero.

In one embodiment of the present invention, the 3D display panel further comprises another protective film disposed between the polarizing film and the quarter wave film.

In one embodiment of the present invention, an inner surface of the quarter wave film is directly in contact with the polarizing film.

In one embodiment of the present invention, the medium is air.

In one embodiment of the present invention, the medium is a zero optical retardation film.

In one embodiment of the present invention, the zero optical retardation film is a zero optical retardation triacetyl cellulose (TAC) film.

In one embodiment of the present invention, the polarizing film is a poly vinyl alcohol (PVA) film.

In one embodiment of the present invention, when bonding the protective film and the quarter wave film to both sides of the polarizing film, the protective film and another protective film are first bonded to both sides of the polarizing film, and then the quarter wave film is bonded on the another protective film.

In comparison with the viewing angle problem existing in the conventional 3D display, with the use of the 3D display panel of the present invention and the method for manufacturing the 3D display sheet, the undesired optical retardation between the 3D display panel and the user's polarizer glasses can be eliminated or reduced for improving the narrow viewing angle problem existing in the conventional 3D display, as well as enhancing a display quality of the 3D display panel.

The structure and the technical means adopted by the present invention to achieve the above-mentioned and other objects can be best understood by referring to the following detailed description of the preferred embodiments and the accompanying drawings.

### DESCRIPTION OF THE DRAWINGS

FIG. 1 is a partially cross-sectional view showing a 3D display panel according to an embodiment of the present invention;

FIG. 2 is a view showing a viewing angle characteristic relating to different cross-talks when a TAC film is bonded to an outer surface of the quarter wave film of the 3D display sheet according to the present invention;

FIG. 3 is a view showing a viewing angle characteristic relating to different cross-talks when the outer surface of the quarter wave film of the 3D display sheet according to the present invention is in contact with ambient air;

FIG. 4 and FIG. 5 are schematic diagrams showing a process for manufacturing the 3D display sheet according to one embodiment of the present invention;

FIG. 6 is a partially cross-sectional view showing a 3D display sheet according to another embodiment of the present invention;

FIG. 7 is a schematic diagram showing a process for manufacturing the 3D display sheet according to the another embodiment of the present invention;

FIG. 8 is a view showing a viewing angle characteristic relating to different cross-talks when the outer surface of the quarter wave film of the 3D display sheet according to the present invention is in contact with ambient air;

FIG. 9 is a partially cross-sectional view showing a 3D display sheet according to a further embodiment of the present invention;

FIG. 10 and FIG. 11 are schematic diagrams showing a process for manufacturing the 3D display sheet according to the further embodiment of the present invention;

FIG. 12 is a view showing a viewing angle characteristic relating to different cross-talks when the outer surface of the quarter wave film of the 3D display sheet according to the present invention is bonded to a zero optical retardation film;

FIG. 13 is a partially cross-sectional view showing a 3D display sheet according to still another embodiment of the present invention;

FIG. 14 is a schematic diagram showing a process for manufacturing the 3D display sheet according to still another embodiment of the present invention; and

FIG. 15 is a view showing a viewing angle characteristic relating to different cross-talks when the outer surface of the quarter wave film of the 3D display sheet according to the present invention is bonded to the zero optical retardation film.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

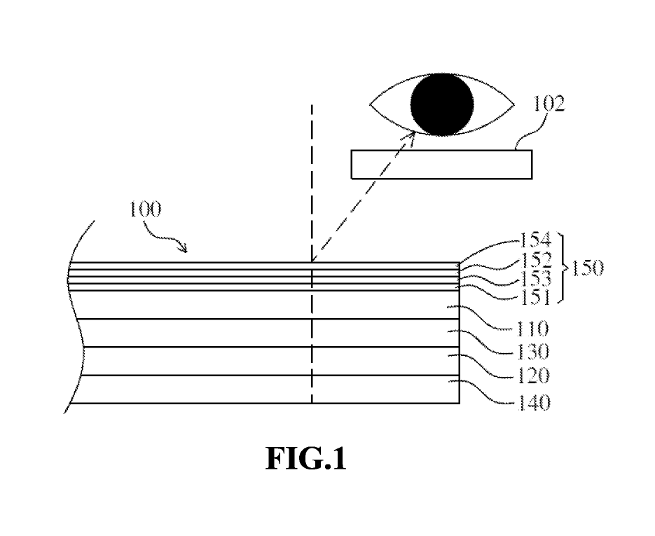

Referring to FIG. 1, a partially cross-sectional view showing a 3D display panel according to an embodiment of the present invention is illustrated. The 3D display panel 100 of the present embodiment is capable of displaying 3D images. The 3D display panel 100 can be assembled with a backlight module (not shown), thereby forming a display apparatus. The display panel 100 is disposed opposite to the backlight module, and the backlight module may be realized as an edge lighting backlight module or a bottom lighting backlight module to provide the 3D display panel 100 with the back-light.

Referring to FIG. 1 again, the display panel 100 of the present embodiment can comprise a first substrate 110, a second substrate 120, a liquid crystal layer 130, a polarizer 140 and a 3D display sheet 150. The first substrate 110 and the second substrate 120 may be realized as glass substrates or flexible plastic substrates. In this embodiment, the first substrate 110 may be a glass substrate or other material substrates with color filters (CF), and the second substrate 120 may be a glass substrate or other material substrates with a thin film transistor (TFT) array. It should be noted that the CF and the TFT array may also be disposed on the same substrate in other embodiments.

Referring to FIG. 1 again, the liquid crystal layer 130 is formed between the first substrate 110 and the second substrate 120. The polarizer 140 is disposed at an outer side of the second substrate 120, and the 3D display sheet 150 is disposed at an outer side of the first substrate 110.

Referring to FIG. 1 again, the 3D display sheet 150 is configured to form circularly polarized rays. The 3D display sheet 150 comprises protective films 151, 152, a polarizing film 153 and a quarter wave film 154. The polarizing film 153 is disposed between the protective films 151 and 152. The quarter wave film 154 is disposed on the protective film 152 for transforming linearly polarized rays which are emitted from the polarizing film 153 into circularly polarized rays. There is a medium between the quarter wave film 154 and a user's polarizer glasses 102, and an outer surface of the quarter wave film 154 is in contact with the medium, wherein the medium has an optical retardation value of zero. In this case, the medium has a first optical retardation value R₀ of zero when light rays are vertically emitted form the quarter wave film 154 and then pass through the medium, and the medium has a second optical retardation value Rₜₕ of zero when light rays are obliquely (non-vertically) emitted form the quarter wave film 154 and then pass through the medium. This is, the medium has the first optical retardation value R₀ when the user views the 3D display panel 100 squarely, and the medium has the second optical retardation value Rₜₕ when user squints at the 3D display panel 100, wherein the first optical retardation value R₀ and second optical retardation value Rₜₕ are of zero (R₀=0, Rₜₕ=0).

Referring to FIG. 1 again, the protective films 151, 152 may be triacetyl cellulose (TAC) films for protecting and supporting the polarizing film 153 and the quarter wave film 154. The polarizing film 153 is disposed close to the first substrate 110 for transforming a light into a linearly polarized light. The polarizing film 153 may be a poly vinyl alcohol (PVA) film.

In this embodiment, the quarter wave film 154 is disposed at an outer side of the 3D display panel 100, and the medium which is in contact with the outer surface of the quarter wave film 154 may be air, and thus the first optical retardation value R₀ and second optical retardation value Rₜₕ thereof are of zero.

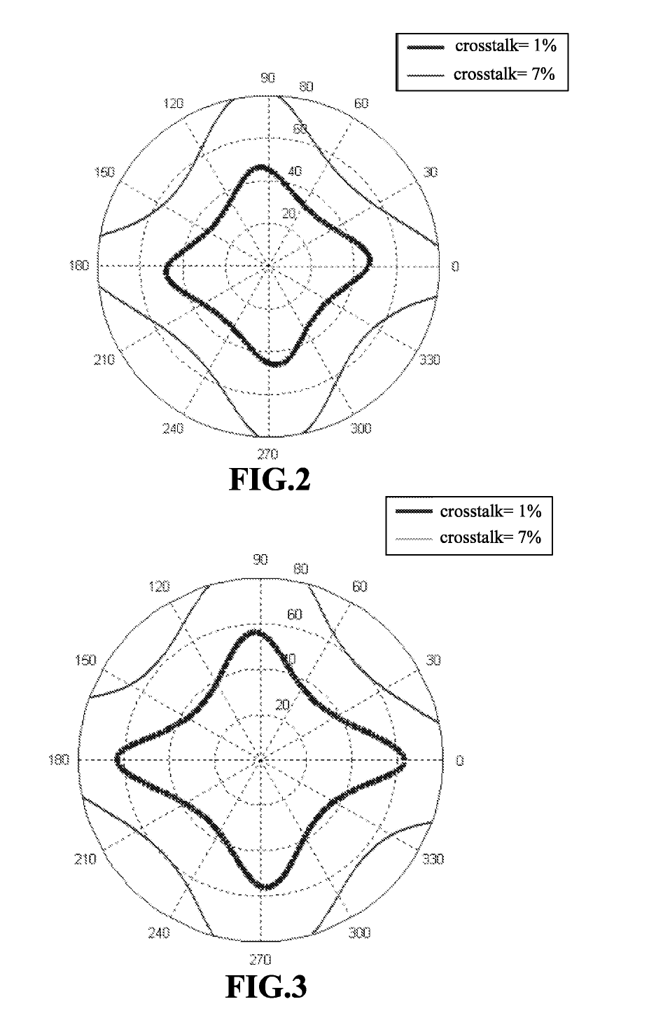

Referring to FIG. 2 and FIG. 3, FIG. 2 is a view showing a viewing angle characteristic relating to different cross-talks when a triacetyl cellulose (TAC) film is bonded to the outer surface of the quarter wave film 154 of the 3D display sheet 150 according to the present invention, and FIG. 3 is a view showing a viewing angle characteristic relating to different cross-talks when the outer surface of the quarter wave film 154 of the 3D display sheet 150 according to the present invention is in contact with ambient air (without the TAC film bonded thereto). In the measured structure corresponding to FIG. 2, the TAC film is bonded to the outer surface of the quarter wave film 154, and the TAC film has different optical retardation value when viewing squarely or squinting at the TAC film, i.e. the first optical retardation value R₀ is different to the second optical retardation value Rₜₕ. Apparently, in comparison with the viewing angle characteristic relating to different cross-talks shown in FIG. 2, the range of the viewing angle shown in FIG. 3 is broader. Therefore, the 3D display sheet 150 corresponding to FIG. 3 can have a broad viewing angle.

In this embodiment, since the quarter wave film 154 of the 3D display sheet 150 is in contact with ambient air, an undesired optical retardation between the 3D display panel 100 and the user's polarizer glasses 102 can be eliminated or reduced. Therefore, when the user wears polarizer glasses 102 to squint at the 3D display panel 100 of the present embodiment, i.e. when an optical path between the user's eyes and of the 3D display panel 100 is not vertical to a plane of the 3D display panel 100, with the use of the 3D display sheet 150, the undesired optical retardation between the 3D display panel 100 and the user's polarizer glasses 102 can be eliminated or reduced, so as to mitigate the image crosstalk, hence improving the narrow viewing angle problem in the conventional 3D display.

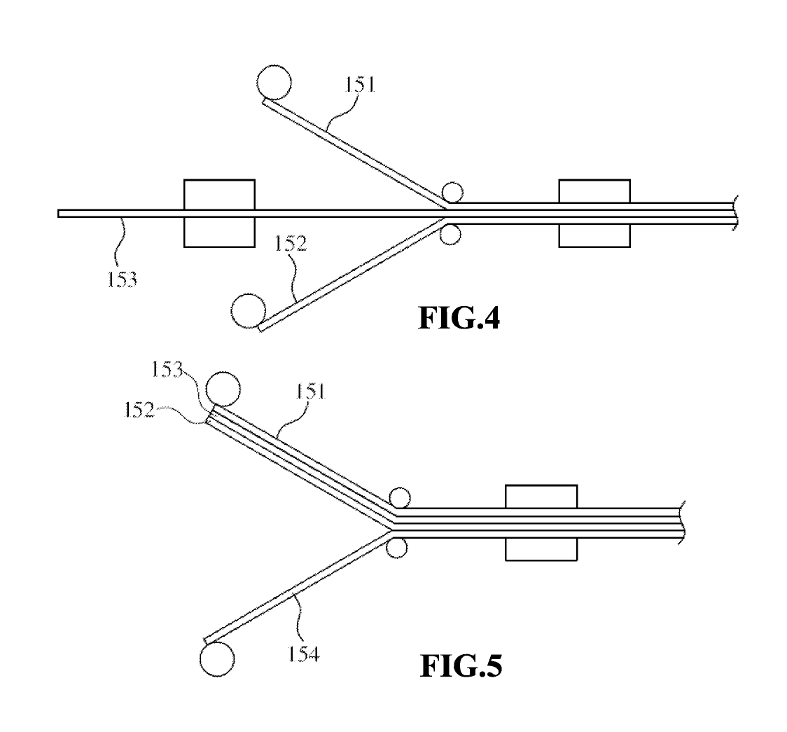

Referring to FIG. 4 and FIG. 5, schematic diagrams showing a process for manufacturing the 3D display sheet according to one embodiment of the present invention are illustrated. When manufacturing the 3D display sheet 150 in this embodiment, referring to FIG. 4 again, the protective films 151 and 152 are first bonded to both sides of the polarizing film 153 by using rollers, respectively. Subsequently, referring to FIG. 5 again, the quarter wave film 154 is bonded to the protective film 152 by using rollers, so as to form the 3D display sheet 150. Subsequently, the assembled 3D display sheet 150 (the two protective films 151 and 152, the polarizing film 153 and the quarter wave film 154) can be dried by a drier, so as to achieve the 3D display sheet 150.

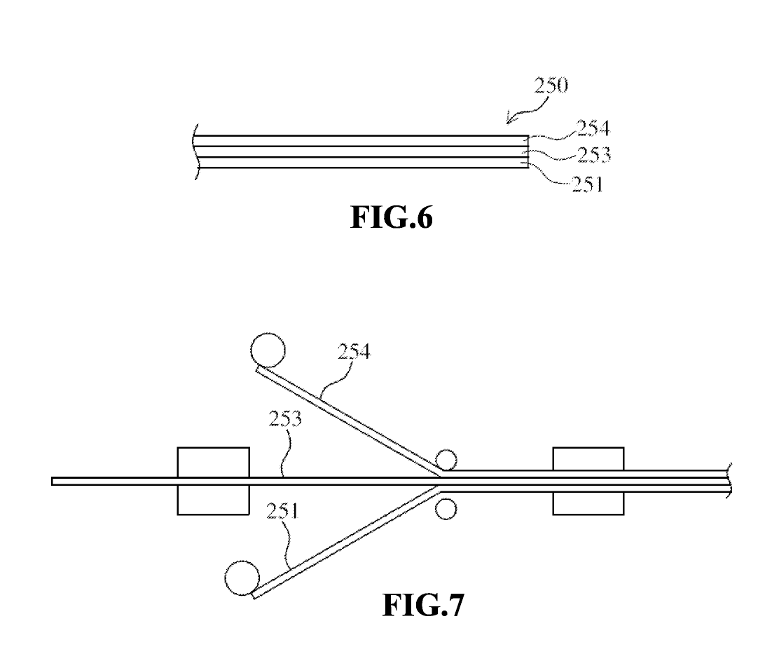

Referring to FIG. 6 and FIG. 7, FIG. 6 is a partially cross-sectional view showing a 3D display sheet according to another embodiment of the present invention, and FIG. 7 is a schematic diagram showing a process for manufacturing the 3D display sheet according to the another embodiment of the present invention. In another embodiment, the protective film 152 is omitted in the 3D display sheet 250, thereby reducing the cost of the protective film. At this time, an inner surface of the quarter wave film 254 is directly in contact with the polarizing film 253, so as to prevent the additional optical retardation between the polarizing film 253 and the quarter wave film 254. Referring to FIG. 7 again, when manufacturing the 3D display sheet 250, the protective films 251 and the quarter wave film 254 can be bonded to both sides of the polarizing film 253 by using rollers, respectively. Subsequently, the assembled 3D display sheet 250 (the two protective film 251, the polarizing film 253 and the quarter wave film 254) can be dried by a drier, so as to achieve the 3D display sheet 250. Therefore, the process for manufacturing the 3D display sheet 250 can be simplified.

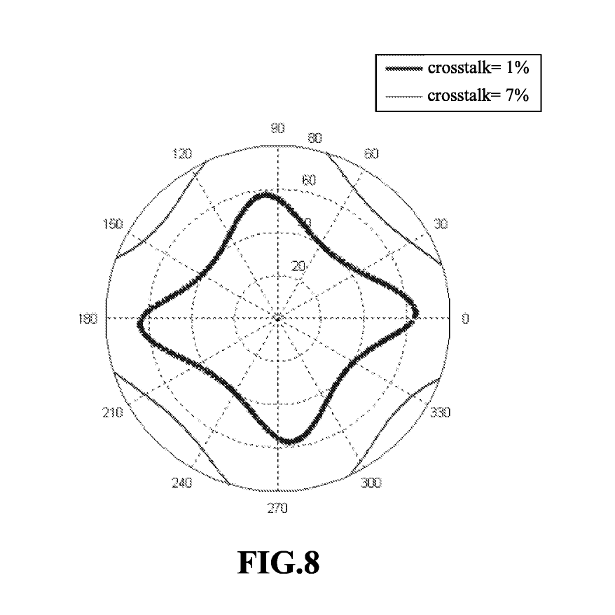

Referring to FIG. 2 and FIG. 8, FIG. 8 is a view showing a viewing angle characteristic relating to different cross-talks when the outer surface of the quarter wave film 254 of the 3D display sheet 250 according to the present invention is in contact with ambient air (without the TAC film bonded thereto). Apparently, in comparison with the viewing angle characteristic relating to different cross-talks shown in FIG. 2, the range of the viewing angle shown in FIG. 8 is broader. Therefore, the 3D display sheet 250 corresponding to FIG. 8 can have a broad viewing angle.

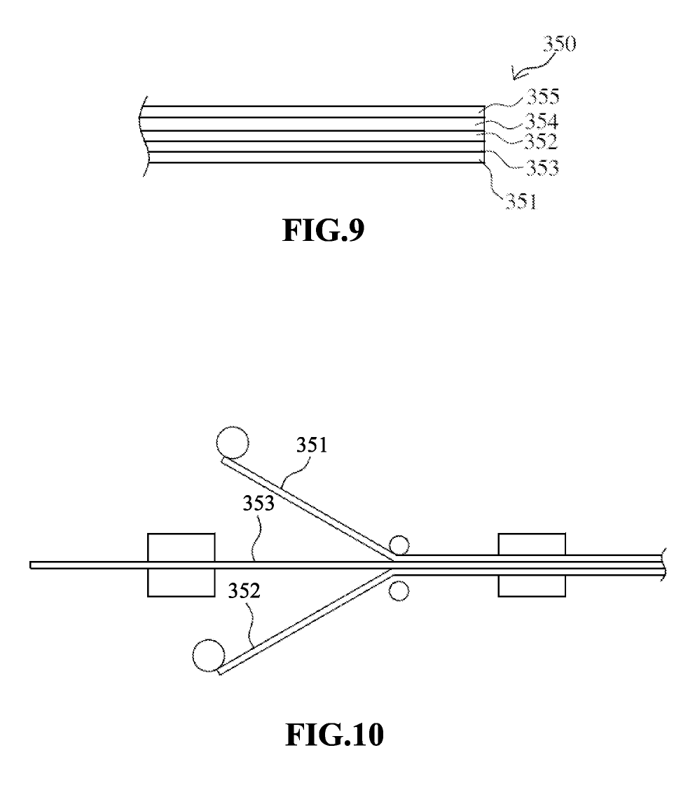

Referring to FIG. 9, a partially cross-sectional view showing a 3D display sheet according to a further embodiment of the present invention is illustrated. In the further embodiment, the 3D display sheet 350 comprises protective films 351, 352, a polarizing film 353, a quarter wave film 354 and a zero optical retardation film 355. The polarizing film 353 is disposed between the protective films 351 and 352. The quarter wave film 354 is disposed between the protective film 352 and the zero optical retardation film 355. The zero optical retardation film 355 is disposed on (bonded to) the outer surface of the quarter wave film 354. This is, the outer surface of the quarter wave film 354 of the 3D display sheet 350 is directly in contact with the zero optical retardation film 355. The zero optical retardation film 355 may be a zero optical retardation TAC film without the first optical retardation value R₀ and second optical retardation value Rₜₕ (hereinafter, referred to as “zero TAC film”). Therefore, the outer surface of the quarter wave film 354 is in contact with the medium (the zero optical retardation film 355) of an optical retardation value of zero.

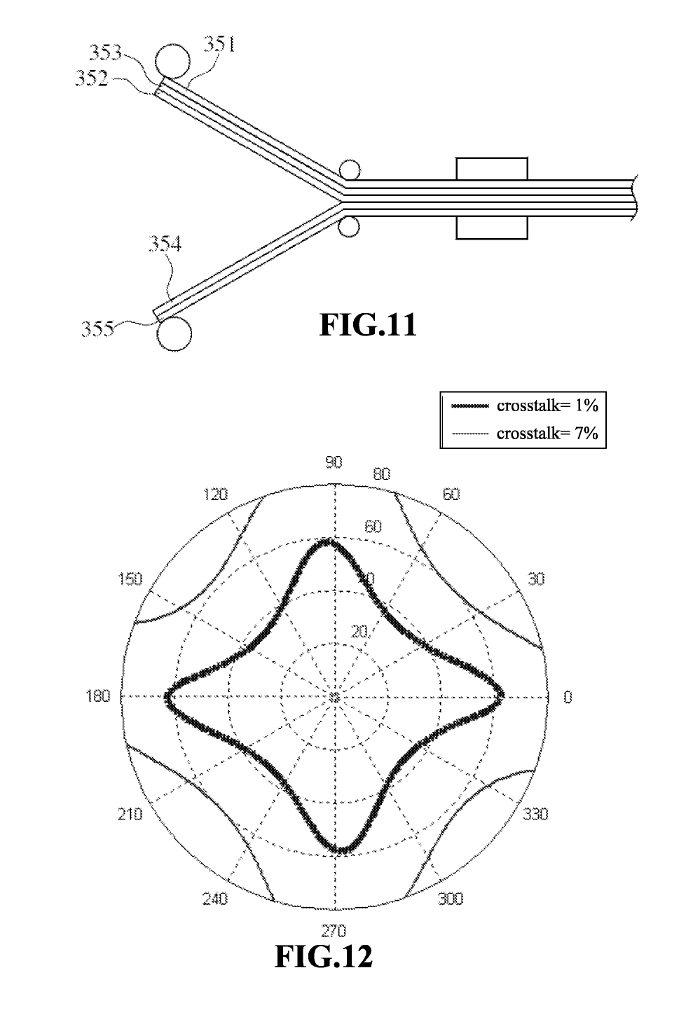

Referring to FIG. 10 and FIG. 11, schematic diagrams showing a process for manufacturing the 3D display sheet according to the further embodiment of the present invention are illustrated. When manufacturing the 3D display sheet 350 in this embodiment, referring to FIG. 10 again, the protective films 351 and 352 are first bonded to both sides of the polarizing film 353 by using rollers, respectively. Subsequently, referring to FIG. 11 again, the quarter wave film 354 and the zero optical retardation film 355 are bonded to the protective film 352 in sequence by using rollers, so as to form the 3D display sheet 350. Subsequently, the assembled 3D display sheet 350 (the two protective films 351 and 352, the polarizing film 353, the quarter wave film 354 and the zero optical retardation film 355) can be dried by a drier, so as to achieve the 3D display sheet 350.

Referring to FIG. 2 and FIG. 12, FIG. 12 is a view showing a viewing angle characteristic relating to different cross-talks when the outer surface of the quarter wave film 354 of the 3D display sheet 350 according to the present invention is in contact with the zero optical retardation film 355. Apparently, in comparison with the viewing angle characteristic relating to different cross-talks shown in FIG. 2, the range of the viewing angle shown in FIG. 12 is broader. Therefore, the 3D display sheet 350 corresponding to FIG. 12 can have a broad viewing angle.

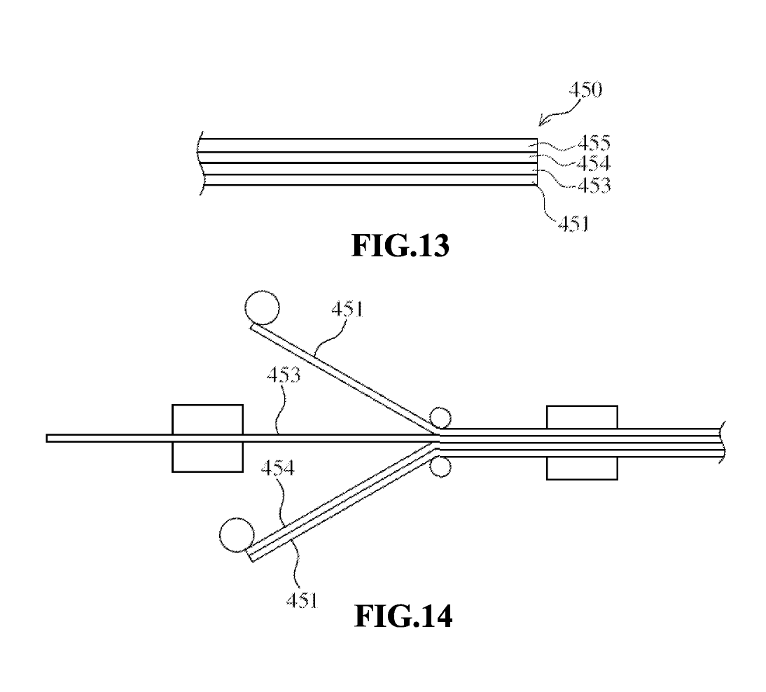

Referring to FIG. 13 and FIG. 14, FIG. 13 is a partially cross-sectional view showing a 3D display sheet according to still another embodiment of the present invention, and FIG. 14 is a schematic diagram showing a process for manufacturing the 3D display sheet according to still another embodiment of the present invention. In the still another embodiment, the 3D display sheet 450 comprises a protective film 451, a polarizing film 453, a quarter wave film 454 and a zero optical retardation film 455. At this time, the quarter wave film 454 is in contact with and bonded between the polarizing film 453 and the zero optical retardation film 455, so as to prevent the additional optical retardation between the polarizing film 453 and the quarter wave film 454. When manufacturing the 3D display sheet 450, the quarter wave film 454 can be first bonded to the zero optical retardation film 455. Subsequently, referring to FIG. 14 again, the protective film 451 and the pre-bonded quarter wave film 454 are bonded to both sides of the polarizing film 453, respectively. Subsequently, the assembled 3D display sheet 450 (the two protective film 451, the polarizing film 453, the quarter wave film 454 and the zero optical retardation film 455) can be dried by a drier, so as to achieve the 3D display sheet 450.

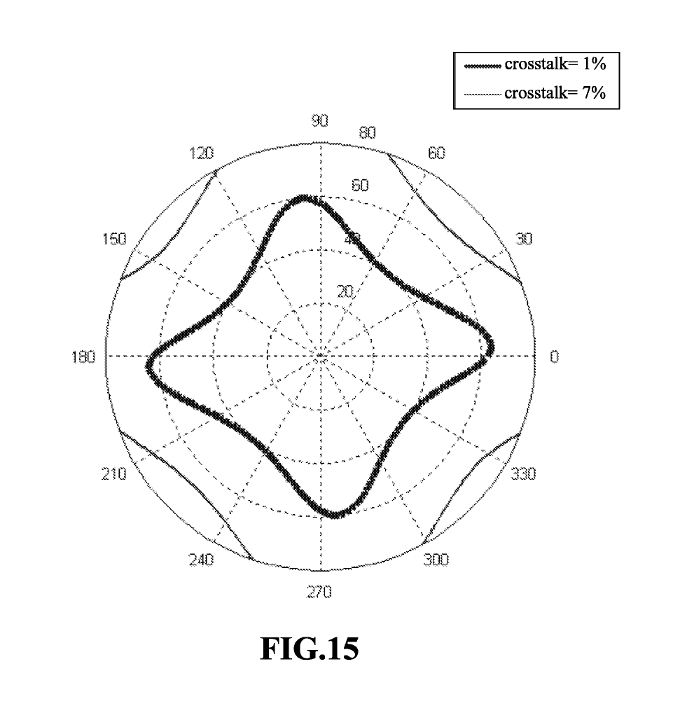

Referring to FIG. 2 and FIG. 15, FIG. 15 is a view showing a viewing angle characteristic relating to different cross-talks when the outer surface of the quarter wave film 454 of the 3D display sheet 450 according to the present invention is bonded to the zero optical retardation film 455. Apparently, in comparison with the viewing angle characteristic relating to different cross-talks shown in FIG. 2, the range of the viewing angle shown in FIG. 15 is broader. Therefore, the 3D display sheet 450 corresponding to FIG. 15 can have a broad viewing angle.

As described above, with the use of the 3D display panel of the present invention and the method for manufacturing the 3D display sheet, the undesired optical retardation between the 3D display panel and the user's polarizer glasses can be eliminated or reduced for improving the narrow viewing angle problem existing in the conventional 3D display, as well as enhancing a display quality of the 3D display panel.

The present invention has been described above with a preferred embodiment thereof, and it is understood that many changes and modifications to the described embodiment can be carried out without departing from the scope and the spirit of the invention that is intended to be limited only by the appended claims.

1. A three-dimensional (3D) display panel, comprising:
a first substrate;
a second substrate;
a liquid crystal layer formed between the first substrate and the second substrate;
a polarizer disposed at an outer side of the second substrate; and
a 3D display sheet disposed at an outer side of the first substrate, wherein the 3D display sheet comprises a protective film, a polarizing film and a quarter wave film, and the polarizing film and the quarter wave film are disposed on the protective film in sequence, and an outer surface of the quarter wave film is directly in contact with a medium, and the medium has an optical retardation value of zero, and an inner surface of the quarter wave film is directly in contact with the polarizing film, and the medium is a zero optical retardation film.

2. The 3D display panel according to claim 1, wherein the zero optical retardation film is a zero optical retardation triacetyl cellulose (TAC) film.

3. The 3D display panel according to claim 1, wherein the polarizing film is a poly vinyl alcohol (PVA) film.

4. A 3D display panel, comprising:
a first substrate;
a second substrate;
a liquid crystal layer formed between the first substrate and the second substrate;
a polarizer disposed at an outer side of the second substrate; and
a 3D display sheet disposed at an outer side of the first substrate, wherein the 3D display sheet comprises a protective film, a polarizing film and a quarter wave film, and the polarizing film and the quarter wave film are disposed on the protective film in sequence, and an outer surface of the quarter wave film is directly in contact with a medium, and the medium has an optical retardation value of zero.

5. The 3D display panel according to claim 4, further comprising another protective film disposed between the polarizing film and the quarter wave film.

6. The 3D display panel according to claim 4, wherein an inner surface of the quarter wave film is directly in contact with the polarizing film.

7. The 3D display panel according to claim 4, wherein the medium is air.

8. The 3D display panel according to claim 4, wherein the medium is a zero optical retardation film.

9. The 3D display panel according to claim 8, wherein the zero optical retardation film is a zero optical retardation TAC film.

10. The 3D display panel according to claim 4, wherein the polarizing film is a PVA film.

11. A method for manufacturing a 3D display sheet of a 3D display panel, comprising the following steps:
providing a polarizing film; and
bonding a protective film and a quarter wave film to both sides of the polarizing film, respectively, wherein an outer surface of the quarter wave film is directly in contact with a medium, and the medium has an optical retardation value of zero.

12. The method according to claim 11, wherein the medium a zero optical retardation film.

13. The method according to claim 11, wherein an inner surface of the quarter wave film is directly in contact with the polarizing film.

14. The method according to claim 11, wherein, when bonding the protective film and the quarter wave film to both sides of the polarizing film, the protective film and another protective film are first bonded to both sides of the polarizing film, and then the quarter wave film is bonded on the another protective film.
